(19) United States
(12) Patent Application Publication
(10) Pub. No.: US 2004/0062395 A1
(43) Pub. Date: Apr. 1, 2004

(54) Receiver for digital broadcast programs in accordance with receiver profile, and billing method therefor

(75) Inventors: Youichi Kondou, Kawasaki (JP); Shinichi Shiotsu, Kawasaki (JP); Isamu Yamada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/661,529

(22) Filed: Sep. 15, 2003

(30) Foreign Application Priority Data
Sep. 18, 2002 (JP) 2002-271190

(51) Int. Cl. H04N 7/167

(52) U.S. Cl. 380/210

(57) ABSTRACT

A receiver includes decoder means for decoding an audio and/or video data stream of a received digital broadcast program; and processor means for storing an identification code of the received digital broadcast program and a profile representative of quality of the decoded audio and/or video data stream.

### FIELD OF THE INVENTION

The present invention relates generally to a receiver and charging for a pay digital broadcast program, and more particularly to a receiver for receiving pay digital television and radio programs in accordance with a profile of the receiver and to charging for the programs.

### BACKGROUND OF INVENTION

While receiving a current pay broadcast satellite (BS) or communication satellite (CS) digital television broadcast signal for example, a set-top box disposed on a television receiver descrambles and reproduces the received pay broadcast program to present to a display. For the purpose of charging for the received pay broadcast program, viewing information related to the reproduced program is recorded in a memory within a smart card called a CAS (Conditional Access System) card that has been inserted into the set-top box. The record of the viewing information is transmitted over a PSTN (Public Switched Telephone Network) via a modem to a viewing information collection center. The records of the viewing information are sorted at the collection center, respective broadcasters are notified of the records of the viewing information, and subscribers to the broadcast services are billed by the broadcasters in accordance with the records of the viewing information. The smart card includes information, such as a unique ID and a decryption key associated with a descramble key used to descramble a scrambled television broadcast program.

In the digital terrestrial television broadcast scheduled in Japan in the near future, broadcast programs will probably be provided to and received by fixed receivers, mobile receivers and portable receivers. The following three sets of different services or profiles for receivers are defined in terms of display resolutions and the like for fixed receivers, mobile receivers and portable receivers.

1. Services for Fixed Receivers:

reception of high quality or definition television signals,

reception of television signals on multi-channels, and

reception of different data broadcast signals for interactive services and the like.

Types of Receivers Therefor:

receivers connected to outdoor antennas, and

mobile receivers which can be also used as fixed receivers

2. Services for Mobile Receivers:

reception of standard television signals of a picture quality that is equivalent to that of current analog television broadcast signals, and

reception of data broadcast signals which are also available in the mobile environments.

Types of Receivers Therefor:

receiving terminals mounted in mobiles, such as automobiles,

compact television receivers including a simplified antenna, and

mobile receivers which can be also used as fixed receivers.

3. Services for Portable Receivers:

reception of television signals of low picture quality or at a low bit rate,

reception of simple motion pictures plus audio signals associated with respective instantaneous pictures provided by data broadcasting, and

reception of broadcast signals representative of data of a combination of simple multimedia encoded characters and mainly still pictures or simple motion pictures.

Types of Receivers Therefor:

compact portable terminals,

terminals having a mobile telephone function and a PDA (Personal Digital Assistant) function, and

personal computers having a receiving function provided by a PC card.

In the current pay-per-view service of pay satellite digital television broadcasting, the subscribers are billed in accordance with the records of the viewing information stored in the smart cards. In the future digital terrestrial television broadcasting, broadcast programs may be widely received and reproduced by mobile receiving terminals, such as notebook personal computers, PDAs and mobile telephones. In the current pay satellite television broadcasting, however, the same policy of charging fees for viewed broadcast programs for the fixed receivers are applied to mobile receivers of low picture quality, such as low definition, as well as the fixed receivers, such as high-definition television apparatuses. Viewers may hesitate to pay relatively high fees for low quality services available on mobile receiving terminals. Thus viewing of digital terrestrial television broadcast programs on mobile receiving terminals may be hindered from spreading.

In Japanese Patent Application Laid-Open Publication (JP-A) No. 2001-18705, published on Jul. 10, 2001, Sugitani discloses a system in which a viewing history including the frequency at which the same digital broadcast program is supplied to respective recipients is recorded, and a fee for that program is lowered as the frequency becomes larger.

In Japanese Patent Application Laid-Open Publication (JP-A) No. 2002-142159, published on May 17, 2002, Yamada et al disclose a personal information storage card which stores personal information including personal favorite initial settings, such as screen configuration, picture quality and sound quality, as well as his or her profile, viewing history and the like. This card is inserted into a digital broadcast receiver, a personal program is then selected and organized by the digital broadcast receiver, and the personal program is presented to the viewer.

The inventors have recognized the need for providing a charging system in accordance with a function of a receiver which is actually used, by allowing the record of viewing information to include a profile, such as a frame rate and a resolution of the receiver.

It is an object of the present invention to provide charging for a broadcast program in accordance with a function of a receiver.

Another object of the invention is to provide charging for a broadcast program in accordance with the quality of service which has been actually used by a receiver.

### SUMMARY OF THE INVENTION

In accordance with an aspect of the present invention, a receiver includes: decoder means for decoding an audio and/or video data stream of a received digital broadcast program; and processor means for storing an identification code of the received digital broadcast program and a profile representative of quality of the decoded audio and/or video data stream.

In accordance with another aspect of the invention, a receiver includes: processor means for storing a predetermined profile representative of quality of an audio and/or video data stream; descrambler means for descrambling a digital signal of a received digital broadcast program to produce an audio and/or video data stream; and decoder means for decoding the produced audio and/or video data stream in accordance with the predetermined profile. The processor means further stores an identification code of the received digital broadcast program.

In accordance with a further aspect of the invention, a receiver includes: processor means for storing a predetermined profile representative of quality of an audio and/or video data stream; descrambler means for descrambling a digital signal of a received digital broadcast program to produce an audio and/or video data stream; and decoder means for decoding the produced audio and/or video data stream in accordance with an actually available profile, when it cannot be decoded in accordance with the predetermined profile. The processor means stores an identification code of the received digital broadcast program and another profile representative of actual quality of an audio and/or video signal decoded by the decoder means.

In an embodiment of the invention, a receiver may include: processor means for storing a predetermined profile representative of quality of an audio and/or video data stream; descrambler means for descrambling a digital signal of a received digital broadcast program to produce an audio and/or video data stream; and decoder means for decoding the produced audio and/or video data stream in accordance with a predetermined profile representative of quality of an audio and/or video data stream. The processor means may store a record associated with the decoding of the produced audio and/or video data stream.

The processor means may be provided in a smart card disposed within the receiver.

The invention is also directed to a program (which maybe stored on a storage medium) for implementing the receiver above.

In accordance with a still further aspect of the invention, a method for calculating charge for reproduced digital broadcast programs, in use for an information processing apparatus, includes the step of receiving an identification code of a digital broadcast program reproduced on a receiver and a profile representative of quality of a reproduced audio and/or video signal of the reproduced digital broadcast program; and the step of calculating a metric of use of the reproduced digital broadcast program in accordance with the profile.

According to the invention, charging for a broadcast program can be provided in accordance with a function of a receiver, and charging for a broadcast program can be provided in accordance with the quality of service which has been actually used by a receiver.

Throughout the drawings, similar symbols and numerals indicate similar items and functions.

### BRIEF DESCRIPTION OF THE DRAWINGS

FIG. 1 shows a configuration of a digital terrestrial television broadcast signal receiver, in accordance with an embodiment of the present invention;

FIG. 2 shows a block diagram for decoding a non-scrambled or scrambled transport stream from a demodulator, in accordance with the embodiment of the invention;

FIG. 3 illustrates transmission of viewing information and a profile among the receiver of a subscriber to a digital terrestrial broadcast pay-per-view service, a viewing information collection center, and broadcaster's facilities;

FIG. 4 shows a block diagram for decoding the non-scrambled or scrambled transport stream from the demodulator, in accordance with another embodiment of the invention; and

FIG. 5 shows a block diagram for decoding the non-scrambled or scrambled transport stream from the demodulator, in accordance with a further embodiment of the invention.

### DESCRIPTION OF THE PREFERRED EMBODIMENTS

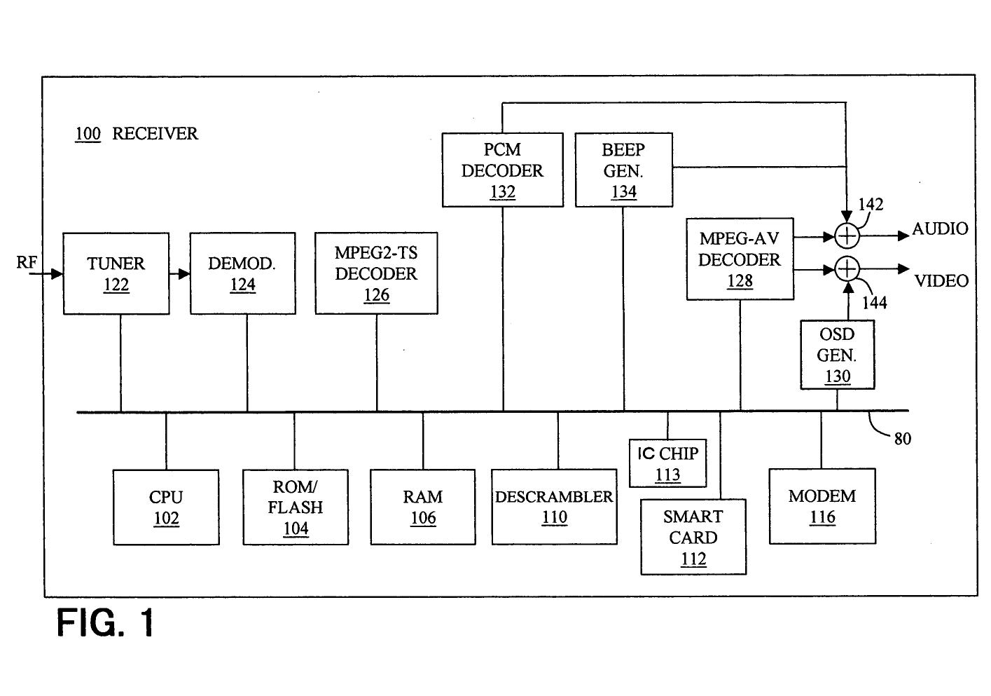

FIG. 1 shows a configuration of a digital terrestrial television broadcast signal receiver 100, such as a set-top box connected to a television receiver, a personal computer (PC) having a receiving function, a PDA having a receiving function, or a mobile telephone having a receiving function, in accordance with an embodiment of the present invention. The receiver 100 includes a CPU 102, a ROM and/or flash memory 104, a RAM 106, a descrambler 110, a smart card 112, a modem 116, a tuner card 122 coupled to a terrestrial antenna (not shown), a demodulator 124, an MPEG2-TS decoder 126, an MPEG-AV decoder 128, an on-screen display (OSD) generator 130, a PCM decoder 132, a beep sound generator 134, and adders 142 and 144, all of which-are interconnected via an internal bus 80. The smart card 112 is a processor which includes a CPU, a ROM, an EEPROM and a RAM, and it has functions of data storage and arithmetic operation. An internal IC chip 113 which is equivalent to an IC chip in the smart card 112 may also be coupled to the internal bus 80, in place of the smart card 112.

The tuner 122 receives RF signals fed from the terrestrial antenna, is synchronized with a channel selected by a user to derive a desired RF signal, and provides the derived RF signal to the demodulator 124. The demodulator 124 downconverts the derived RF signal to an intermediate frequency (IF) signal, further downconverts the IF signal to a baseband signal, and demodulates it to produce a baseband transport stream (TS), which may be non-scrambled or scrambled.

The non-scrambled transport stream is provided to the MPEG2-TS decoder 126. The scrambled transport stream is first provided to the descrambler 110. The descrambler 110 generates a descrambled transport stream using a descramble key which can be obtained in a manner described later, and provides the descrambled transport stream to the MPEG2-TS decoder 126.

The MPEG2-TS decoder 126 operates as a demultiplexer, detects an identifier within the header of a packetized elementary stream (PES) in the transport stream, and extracts separate packetized or unpacketized audio and video elementary data streams (PES or ES) to provide these to the MPEG-AV decoder 128. The MPEG-AV decoder 128 decodes the audio and video data streams while causing them to be buffered by RAM 106, and provides the decoded audio and video signals to respective inputs of the respective adders 142 and 144.

The PCM decoder 132 decodes audio data associated with a data broadcast signal to reproduce an audio signal, and provides the reproduced audio signal to another input of the adder 142. The beep sound generator 134 generates a beep sound signal in accordance with an audio code from the CPU 102 to provide the signal to the other input of the adder 142. The adder 142 adds both of the audio signal from the PCM decoder 132 and the beep sound signal from the beep sound generator 134 to the audio signal from the MPEG-AV decoder 128, to provide a combined audio signal to a speaker (not shown).

The OSD generator 130 generates an on-screen display (OSD) signal, and supplies the OSD signal to another input of the adder 144. The adder 144 adds the OSD signal from the OSD generator 120 to the video signal from the decoder 128, to provide a combined video signal to a video display (not shown).

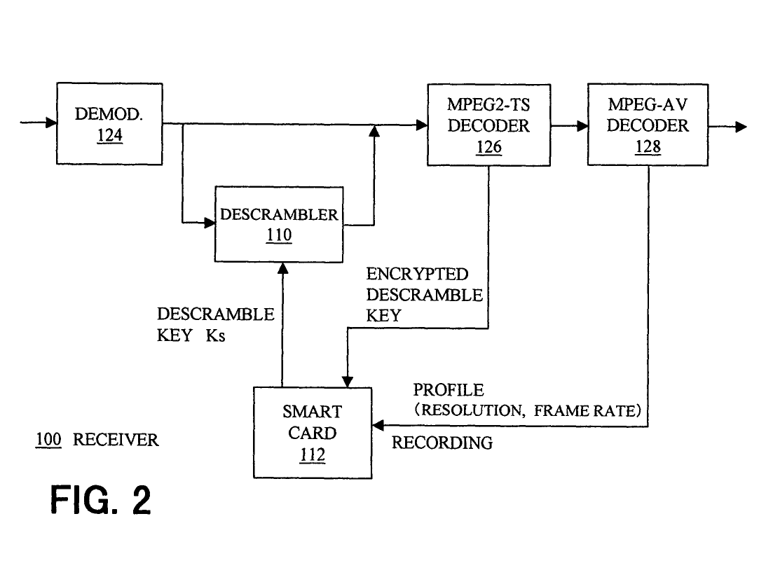

FIG. 2 shows a block diagram for decoding the non-scrambled or scrambled transport stream (TS) from the demodulator 124, in accordance with the embodiment of the invention. FIG. 2 can also be seen as a flow diagram for decoding the non-scrambled or scrambled transport stream from the demodulator 124, which is controlled by the CPU 102 in accordance with a program stored in the ROM 104 or the RAM 106.

The non-scrambled transport stream from the demodulator 124 is provided to the MPEG2-TS decoder 126. The scrambled transport stream from the demodulator 124 is provided to the descrambler 110.

The descrambler 110 receives a descramble key Ks from the smart card 112, descrambles the scrambled transport stream in accordance with this key, and provide the descrambled transport stream to the MPEG2-TS decoder 126.

A scrambled broadcast program is broadcasted together with an encrypted descramble key for that program. The MPEG2-TS decoder 126 provides the encrypted descramble key from the demodulator 124 to the smart card 112. The smart card 112 decrypts the encrypted descramble key using a decryption key within its memory, produces a decrypted descramble key, and provides the decrypted descramble key to the descrambler 110. The descrambler 110 descrambles the transport stream of the scrambled broadcast program using the descramble key, and provides the descrambled transport stream to the MPEG2-TS decoder 126. A specific encrypted descramble key can be decrypted only by a specific smart card to produce a decrypted descramble key.

The MPEG2-TS decoder 126 provides the separated audio and video data streams (PES or ES) to the MPEG-AV decoder 128.

The MPEG-AV decoder 128 provides, to the smart card 112, a profile representative of the quality of the reproduced audio and/or video or a profile representative of the capabilities of the receiver 100. The smart card 112 records an identification of the broadcast program being currently descrambled or decoded together with the profile in its memory.

The profile also includes the resolution or definition and frame rate of the reproduced video, the quality of the reproduced audio, such as stereo, monaural, 5.1 channel, or the like. Alternatively, the profile may include an identification of the receiver 100 that indicates whether it is a high definition television receiver, a standard definition television receiver, a personal computer, a PDA, a mobile telephone or the like. The identification of the receiver 100 represents the resolution and frame rate of the video and the quality of the audio which are specific to that receiver.

The resolution of a high definition television receiver is, for example, 1920×1080 pixels with the aspect ratio of 16:9 in compliance with the digital terrestrial television broadcast standard. The resolution of a standard definition television receiver is, for example, 720×480 pixels with the aspect ratio of 16:9 or 4:3 in compliance with the digital terrestrial television broadcasting standard. The resolutions for reproduction of a television signal by personal computers are, for example, 800×600 pixels, 1024×768 pixels, 1280×1024 pixels and the like. The resolutions for reproduction of a television signal by PDAs are, for example, 240×320 pixels, 640×480 pixels and the like. The resolutions for reproduction of a television signal by mobile telephones are, for example, 120×160 pixels, 176×220 pixels, 240×320 pixels and the like.

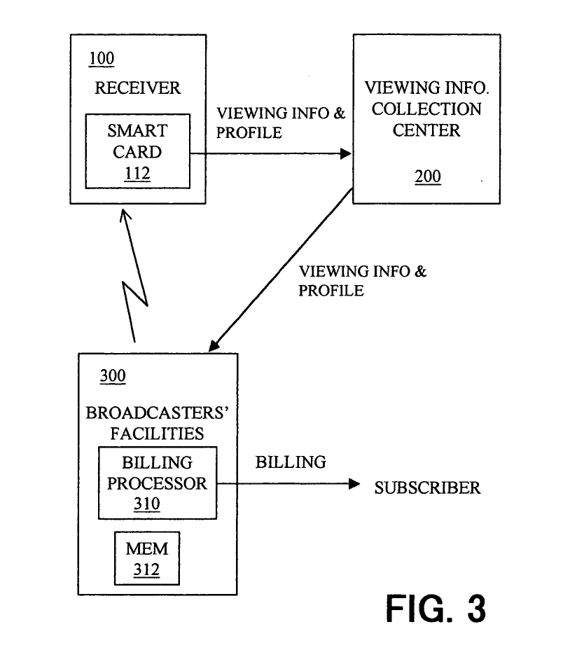

FIG. 3 illustrates transmission of the viewing information and the profile among the receiver 100 of the subscriber to a digital terrestrial broadcast pay-per-view service, a viewing information collection center 200, and broadcasters' facilities 300. The smart card 112 of the receiver 100 in FIG. 1 records, in its memory, the identification of the descrambled or decoded broadcast program and the profile for reproduction. The identification of the broadcast program and the profile recorded in the memory of the smart card 112 of the receiver 100 are transmitted via the modem 116 over a PSTN to the information collection center 200 regularly or after the reproduction of each broadcast program. The records of the identifications of the broadcast programs and the profiles associated therewith are sorted at the collection center 200 and transmitted to the respective broadcasters' facilities 300. A billing processor 310 of the broadcaster 300, which operates in accordance with a program stored in a memory device 312, receives the records of the identifications of the broadcast programs and the associated profiles, calculates the fees for the broadcast programs in accordance with the associated profiles for each subscriber, and bills that subscriber for the sum total of the fees on a monthly basis. The highest amount is charged for broadcast programs having associated profiles of the highest picture quality and/or sound quality. The second highest amount is charged for broadcast programs having associated profiles of the second highest picture quality and/or sound quality. The lowest amount is charged for broadcast programs having associated profiles of the lowest picture quality and/or sound quality.

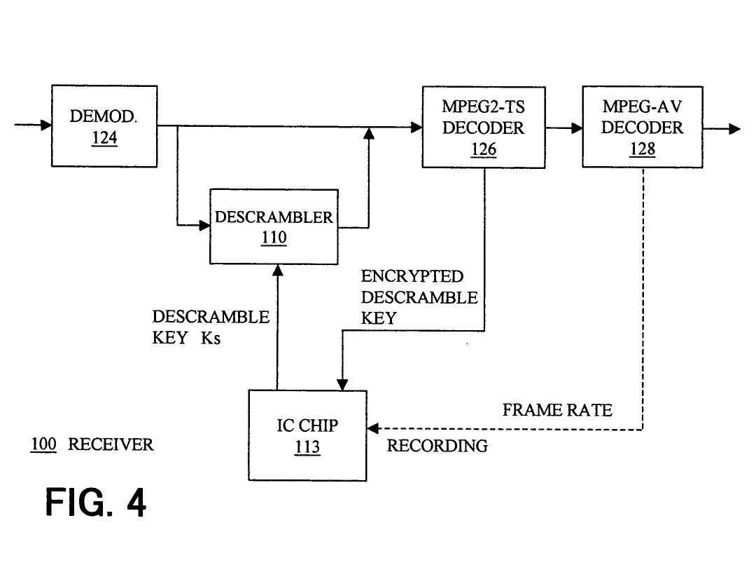

FIG. 4 shows a block diagram for decoding the non-scrambled or scrambled transport stream from the demodulator 124, in accordance with another embodiment of the invention. FIG. 4 can also be seen as a flow diagram for decoding the non-scrambled or scrambled transport stream from the demodulator 124, which is controlled by the CPU 102 in accordance with a program stored in the ROM 104 or the RAM 106.

In FIG. 4, an IC chip 113 is disposed within the receiver 100 in lieu of the smart card 112. When the quality of the audio and/or video, e.g. the resolution, in the receiver 100 is fixed or predefined, a fixed profile representing that quality may be prestored in the IC chip 113. Alternatively, the fixed profile may be prestored in the memory 104 or 106 in the receiver 100. The IC chip 113 records, in its memory, only an identification code of the descrambled or decoded broadcast program. The MPEG-AV decoder 128 is not required to provide the profile to the smart card 112.

When the viewing information collection center 200 is required to collect the frame rate for reproduction in the receiver 100 in addition to the fixed resolution prestored in the IC chip 113, the MPEG-AV decoder 128 maybe adapted to provide the reproduced frame rate to the smart card 112. Other operations of the receiver 100 in FIG. 4 are similar to those of FIG. 2 and will not be described again.

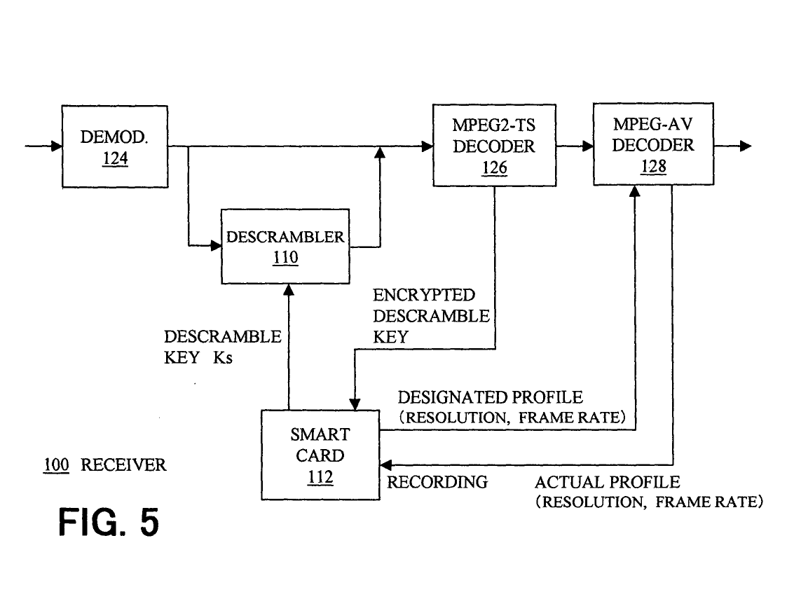

FIG. 5 shows a block diagram for decoding the on-scrambled or scrambled transport stream from the demodulator 124, in accordance with a still further embodiment of the invention. FIG. 5 can also be seen as a flow diagram for decoding the non-scrambled or scrambled transport stream from the demodulator 124, which is controlled by the CPU 102 in accordance with a program stored in the ROM 104 or the RAM 106.

In FIG. 5, the fixed profile is prestored as subscriber information in the memory of the smart card 112 such as an insertable CAS card. The smart card 112 designates profiles such as available resolutions and frame rates for the MPEG-AV decoder 128, and stores the profile actually used by the MPEG-AV decoder 128. When the MPEG-AV decoder 128 of the receiver 100, into which the smart card 112 has been inserted, is about to start reproducing a broadcast program with a profile of quality equal to or lower than that of the fixed profile, the smart card 112 provides the descramble key Ks to the descrambler 110.

When the MPEG-AV decoder 128 of the receiver 100, into which the smart card 112 has been inserted, is about to start reproducing a broadcast program with a profile of higher quality than that of the fixed profile, or when it can reproduce a broadcast program with only a profile of higher quality than that of the fixed profile, the smart card 112 inhibits the provision of the descramble key Ks to the descrambler 110. Thus, the broadcast program is prevented from being reproduced with a profile of higher quality than that of the fixed profile.

The identification of the broadcast program and the profile associated therewith recorded in the memory of the smart card 112 are transmitted, similarly to those of FIG. 3, to the information collection center 200 via the modem 116 over the PSTN regularly or after the reproduction of each broadcast program.

Other operations of the receiver 100 in FIG. 5 are similar to those of FIGS. 2 and 4, and will not be described again.

Alternatively, the smart card 112 may be a prepaid card which enables reproduction of limited broadcast programs in accordance with a designated profile in a particular condition, for example, for a predetermined period of time, such as one month, a limited number of programs, a limited amount of money, or a limited total number of reproduction hours, such as fifty hours. In this case, the smart card 112 records, in its memory, the identifications of the descrambled or decoded broadcast programs and the applied reproduction profiles therefor. In accordance with the identifications of the broadcast programs and the applied reproduction profiles, the smart card 112 calculates and records in its memory the total number of times of viewing and amount of charges expended for reproduction, a remaining available period of time, a remaining number of available broadcast programs, or a remainder of the designated amount of prepayment. When a particular smart card 112 is associated with a particular broadcaster and the fee of the particular smart card 112 is to be prepaid to the particular broadcaster, or when the fee of one smart card 112 is properly shared among a plurality of broadcasters independently of actually viewed programs, however, the smart card 112 is not required to transmit the record of the viewing information to the collection center 200, and the collection center 200 is not required to transmit the record of the viewing information to the broadcaster 300.

The above-described embodiments are only typical examples, and their modifications and variations are apparent to those skilled in the art. It should be noted that those skilled in the art can make various modifications to the above-described embodiments without departing from the principle of the invention and the accompanying claims.

What is claimed is:

1. A receiver comprising:
decoder means for decoding an audio and/or video data stream of a received digital broadcast program; and
processor means for storing an identification code of said received digital broadcast program and a profile representative of quality of said decoded audio and/or video data stream.

2. The receiver according to claim 1, further comprising means for transmitting, to another apparatus, both of said identification code of said received digital broadcast program and said profile which are stored in said processor means.

3. The receiver according to claim 1, further comprising
demodulator means for demodulating a digital signal of said received digital broadcast program; and
descrambler means for descrambling said demodulated digital signal to produce said audio and/or video data stream.

4. The receiver according to claim 1, wherein said profile includes description of a resolution or frame rate of a reproduced picture.

5. The receiver according to claim 1, wherein said profile includes description of stereo, monaural, or 5.1 channel of a reproduced sound.

6. A receiver comprising:
processor means for storing a predetermined profile representative of quality of an audio and/or video data stream;
descrambler means for descrambling a digital signal of a received digital broadcast program to produce an audio and/or video data stream; and
decoder means for decoding said produced audio and/or video data stream in accordance with said predetermined profile;
said processor means further storing an identification code of said received digital broadcast program.

7. The receiver according to claim 6, further comprising means for transmitting, to another apparatus, both of said identification code of said received digital broadcast program and said profile which are stored in said processing means.

8. The receiver according to claim 6, wherein, when said produced audio and/or video data stream is decoded, said processor means stores other profile data representative of actual quality of said decoded audio and/or video data stream.

9. A receiver comprising:
processor means for storing a predetermined profile representative of quality of an audio and/or video data stream;
descrambler means for descrambling a digital signal of a received digital broadcast program to produce an audio and/or video data stream; and
decoder means for decoding said produced audio and/or video data stream in accordance with an actually available profile, when it cannot be decoded in accordance with said predetermined profile;
said processor means storing an identification code of said received digital broadcast program and another profile representative of actual quality of an audio and/or video signal decoded by said decoder means.

10. The receiver according to claim 9, further comprising means for transmitting, to another apparatus, both of said identification code of said received digital broadcast program and said profile which are stored in said processor means.

11. The receiver according to claim 9, wherein, when said decoder means decodes said produced audio and/or video data stream in accordance with said predetermined profile, said processor means allows said descrambler means to perform the descrambling.

12. The receiver according to claim 1, wherein said processor means is provided in a smart card disposed within said receiver.

13. An apparatus comprising billing means, said billing means receiving both of an identification code of a digital broadcast program reproduced on a receiver and a profile representative of quality of a reproduced audio and/or video signal of said reproduced digital broadcast program, said billing means calculating a metric of use of said reproduced digital broadcast program in accordance with said profile.

14. A program for a receiver stored on a storage medium, said program being operable to execute the steps of:
causing an audio and/or video data stream of a received digital broadcast program to be decoded; and
storing an identification code of said received digital broadcast program and a profile representative of quality of said decoded audio and/or video data stream.

15. A program for a receiver stored on a storage medium, said program being operable to execute the steps of:
causing a digital signal of a received digital broadcast program to be descrambled to produce an audio and/or video data stream;
causing said produced audio and/or video data stream to be decoded in accordance with a predetermined profile representative of quality of an audio and/or video data stream; and
storing an identification code of said digital broadcast program, and a predetermined profile representative of quality of said produced audio and/or video data stream.

16. The program according to claim 15, being operable to further execute the step of causing both of said stored identification code of said received digital broadcast program and said profile to be transmitted to another apparatus.

17. The program according to claim 15, being operable to further execute the step of storing other profile data representative of actual quality of said decoded audio and/or video data stream, when said produced audio and/or video data stream is decoded.

18. A program for a receiver stored on a storage medium, said program being operable to execute the steps of:
causing a digital signal of a received digital broadcast program to be descrambled to produce an audio and/or video data stream;
causing said produced audio and/or video data stream to be decoded in accordance with an actually available profile, when it cannot be decoded in accordance with a predetermined profile representative of quality of an audio and/or video data stream; and
storing an identification code of said digital broadcast program, and another profile representative of actual quality of said decoded audio and/or video signal.

19. The program according to claim 18, being operable to further execute the step of transmitting, to another apparatus, both of said stored identification code of said received digital broadcast program and said profile.

20. A program for a receiver stored on a storage medium, said program being operable to execute the steps of:
causing a digital signal of a received digital broadcast program to be descrambled to produce an audio and/or video data stream; and
causing said produced audio and/or video data stream to be decoded in accordance with a predetermined profile representative of quality of an audio and/or video data stream.

21. A program for a receiver stored on a storage medium, said program being operable to execute the steps of:
receiving both of an identification code of a digital broadcast program reproduced on a receiver and a profile representative of quality of a reproduced audio and/or video signal of said reproduced digital broadcast program; and
calculating a metric of use of said reproduced digital broadcast program in accordance with said profile.

22. In an information processing apparatus, a method for calculating charges for reproduced digital broadcast programs, said method comprising the steps of:
receiving both of an identification code of a digital broadcast program reproduced on a receiver and a profile representative of quality of a reproduced audio and/or video signal of said reproduced digital broadcast program; and
calculating a metric of use of said reproduced digital broadcast program in accordance with said profile.
